(19) United States
(12) Patent Application Publication
(10) Pub. No.: US 2023/0062841 A1
(43) Pub. Date: Mar. 2, 2023

(54) COMPOSITE TANK INNER SHELL FOR HIGH PRESSURE GAS

(71) Applicant: SA SARDOU, Saint-Soupplets (FR)

(72) Inventors: Max SARDOU, Saint-Soupplets (FR); Patricia SARDOU, Saint-Soupplets (FR)

(21) Appl. No.: 17/889,177

(22) Filed: Aug. 16, 2022

(30) Foreign Application Priority Data
Aug. 11, 2021 (FR) 2108636

(51) Int. Cl. F17C 1/14

(52) U.S. Cl. CPC F17C 1/14; F17C 2203/0604; F17C 2203/0646; F17C 2201/0109; F17C 2209/2181; F17C 2209/232; F17C 2221/012

(57) ABSTRACT

Disclosed are thin-walled metal liners, for composite tank, type III, preferably designed to contain gases or hydrogen under high pressure, intended for land, sea, air and space transport, as well as static storage. This liner consists of a main cylinder of revolution, terminated, at least at one of its ends, by an evolutionary shape, substantially hemispherical, gradually connecting to its pole on a cylindrical part of smaller diameter than the main cylinder, the second end of the main cylinder may be either substantially identical to the first, is called “one-eyed” that is to say that it has an evolutionary shape, substantially in the entire hemisphere, that is to say without cylindrical part of smaller diameter than the main cylinder, at its pole.

### CROSS-REFERENCE TO RELATED PRIORITY APPLICATION

This application claims priority to FR 2108636 filed Aug. 11, 2021, the entire contents of each of which are hereby incorporated by reference.

### BACKGROUND OF THE INVENTION

### Field of the Invention

A liner is the inner shell of a high-pressure gas tank, and in particular for hydrogen. The said tank is intended for land, sea, air and space transport, as well as static storage.

The present invention relates to liners (5) for high-performance composite tanks having at identical volume, substantially the inner shape of a conventional liner, that is to say a main cylinder of revolution (5), terminated, at least at one of its ends, by an evolutionary shape, substantially in hemisphere (5c), gradually connecting to its pole on a cylindrical part (5b′) of smaller diameter than the main cylinder. see FIG. 10.

The second end of the main cylinder (5′b′) may be substantially identical to the first, (symmetrical configuration); is called “one-eyed” that is to say that it has an evolutionary shape, substantially in the entire hemisphere, that is to say without cylindrical part of smaller diameter than the main cylinder, at its pole, (asymmetrical configuration).

### Description of the Related Art

There are four main types of compressed gas storage tanks:
Type I corresponds to a thick metal envelope acting, to the faith, as a structural part and liner,
Type II comprises a metal liner whose cylindrical part is reinforced by a composite (fiber+resin) wound circumferentially by winding. With this type of tank, the liner supports a large part of the load due to pressurization, so it is structural.
Type III is a liner entirely wound by resin-coated fiber (composite structure). The liner is metallic, it does support partially the load and is also there to prevent the permeation of hydrogen. This type of liner provides access to high static pressures, for example to 700 bar of service.
Type IV is a liner entirely wound by resin-coated fiber (composite structure). The liner is made of polymer, for example high-density polyethylene (HDPE), it does not support the load and is only there to prevent hydrogen permeation. It should be noted that permeation is still an obstacle to the large-scale use of this type of tank, as well as the slowness (more than 10 minutes) and the difficulty of production of the liner. This type of liner provides access to high working pressures (700 bar). The composite structure is usually carbon fiber coated with epoxy resin.

Type III & IV tanks use almost exclusively their composite structure to ensure good mechanical resistance to pressure.

Type III tanks, classic, use metal liners with wall thicknesses between 10 and 15 mm. The complexity and extreme slowness of the manufacturing process of such a liner is considerable. It takes a time of about half an hour to make it! In addition, this liner is mainly made with an aluminum alloy grade A6061. Such an alloy has a very low elongation at break, it is a handicap for the fatigue behavior!

In the U.S. Pat. No. 3,943,867 A (Erfurt Horst-Lothar) describe a liner having a wall thickness of part 5, comprised between 1 and 3 mm, this is much too thick compared to our goal

In the U.S. Pat. No. 5,964,117A (Holroy Nigel) describe a liner having a wall thickness of part 5, below 0.1 mm, this is not adapted to our goal the wall is too thin

### SUMMARY OF THE INVENTION

For example, it should be noted that hydrogen permeability at 25 C:
of High-Density Polyethylene (HDPE) is 2×10⁻¹³ (moleH²·M⁻¹·S⁻¹·Mpa^{-1/2})
of aluminum is 6×10⁻¹⁶ (moleH²·M⁻¹·S⁻¹·Mpa^{-1/2})

We can therefore see, at the same thickness, that there is a difference in permeability of 333 times between that of aluminum and that of HDPE! Table 1 gives the typical thickness of a HDPE liner for a Type IV tank, i.e. 7 mm. Such a thickness, for an internal capacity of 62 liters, induces a mass roughly equal to 5.66 Kg, or 12% of the total mass of said tank, which is far from negligible!

In addition, the liner is not structural, for a liner of 372 mm inner diameter, the composite structure will have an internal diameter of 386 mm and will therefore have to withstand a stress 3.8% higher than that which it would have to undergo for a diameter of 372 mm. It is therefore necessary to realize the composite structure with more thickness, therefore more mass and more cost.

It should also be noted that the “threaded part” (5^{th}) used to connect the external piping, is obtained by threading the end (5b) of the ½ liner.

“Second end” called “one-eyed”, having an evolutionary shape, substantially in the entire hemisphere, that is to say without cylindrical part of smaller diameter than the main cylinder, at its pole, (asymmetrical configuration). This “second end” requires specific backward extrusion tooling. It is well specified that, on the figures, the same references designate the same elements, whatever the figure on which they appear and whatever the form of representation of these elements. Similarly, if elements are not specifically referenced on one of the figures, their references can be easily found by referring to another figure.

The applicant also wishes to specify that the figures represent an embodiment of the object according to the invention, but that there may be other embodiments that meet the definition of this invention.

It further specifies that, where, according to the definition of the invention, the object of the invention comprises “at least one” element having a given function, the embodiment described may comprise several of these elements.

It also clarifies that; the term substantially can mean that the property so qualified can be understood either as being exactly or as almost defined. For example, the property “this end of the tube substantially flush with the end of the insert” can mean either that the end is flush exactly, or that it comes within a reasonable proximity to the end of the insert.

It also specifies that, if the embodiments of the object, according to the invention, as illustrated comprise several elements of identical function and that if, in the description, it is not specified that the object according to this invention must necessarily comprise a particular number of these elements, the object of the invention may be defined as comprising “at least one” of these elements.

Finally, it is specified that where, in this description, an expression alone defines, without any specific mention concerning it, a set of structural characteristics, these characteristics may be taken, for the definition of the object of the protection requested, where technically possible, either separately or in total and/or partial combination.

### Definition and Essential Notions

Backward extrusion (see FIG. 6): backward extrusion makes it possible to produce a tube with a bottom (usually called an extremity, and here called liner or ½ liner). Backward extrusion lengths are necessarily relatively short. Backward extrusion is used for the manufacture of armament components (shell casing, warhead, flask), steel or aluminum alloy gas cylinders. The forms are limited. Backward extrusion has the following steps. Step [A]: The blank (3) (e.g. aluminum), heated or cold and lubricated and is placed in a matrix closed at one end by a cup (2) (left drawing FIG. 3). Step [B]: A punch (1) grows on the blank that runs along the punch forming a case (5) (central drawing FIG. 3). Step [C]: At the end of backward extrusion, the case is ejected thanks to a push on the cup (drawing on the right FIG. 3).

Permeation: see FIG. 2; In physics and engineering, permeation is the penetration of a permeate (liquid, gas or vapor) through a solid. It is directly related to: the concentration gradient of the permeate, the intrinsic permeability of the material, and its mass diffusivity. Permeation is modeled by equations such as Fick's laws of diffusion, and can be measured using tools such as a permeameter. Permeation can occur through most materials, including metals, ceramics, and polymers. However, the permeability of metals is much lower than that of ceramics and polymers due to their crystal structure and low porosity.

Annealing: the annealing, of a metal part, is a process corresponding to a heating cycle. This consists of a step of gradual rise in temperature, typically to 300° C., followed by a time of maintenance at said temperature. This procedure, allows to modify the physical characteristics of the metal. This action is particularly used to facilitate the relaxation of stresses that may have accumulated at the heart of the material, under the effect of mechanical or thermal stresses, involved in the stages of synthesis and shaping of materials. On the occasion of an annealing, the grains (single crystals) of matter are reformed and regain in a way, their “state of equilibrium”. Crystallization annealing, after work hardening, aims to give the metal an optimal grain size for its future use (folding, stamping, backward extrusion . . . ).

Tooling: here we designate by tooling the punch assembly (1) and counterform (2)

Bottle: in the text we designate indifferently by: liner ½½ liner½½ bottle ‘5D’) or “D”), we designate per bottle (5D) the set of t½ ½ bottles. FIG. 10.

### Backward Extrusion Parameters:

The backward extrusion ratio OR is an assessment of the stringing severity.

It is written:

$$δ R = \frac{S}{s}$$

with:

s: draft or blank metal preform section (3)

S: section of the drawback product (5).

### Backward Extrusion Force:

Obtaining thin walls of large diameter, in backward extrusion, is extremely delicate; this is the reason why current Type III tanks have thick and heavy walls.

The backward extrusion force makes it possible to know the force necessary for a given deformation and will make it possible to know, in practice, the press that will have to be used. The simplified backward extrusion force is written:

$$F = π . {R}^{2} . ρ . ln δ . exp ( \frac{2. f . l}{R} )$$

with

F (daN): force to be applied to the punch (1)

R (mm): radius of the blank (3)

ρ(daN/mm²“: “resistance to deformat”on” (see FIG. 11) of the material at the strain temperature (also called flow stress)

δ: ratio between the section of the blank and the section of the finished product at the deformation temperature (called backward extrusion ratio)

l (mm): length of the blank

f: coefficient of friction between the blank (3) and the walls (1) and (2), this coefficient also depends on the thickness of the wall (5) of t½½ bottle.

### Deformation Speed:

The rate of deformation of the blank, during backward extrusion, is the derivative, with respect to time, of the deformation ε; it is therefore note “(“epsilon po”nt”):

$$\dot{ε} = \frac{\partial ε}{\partial t} .$$

It is expressed in s⁻¹

### Resistance to Deformation:

strain resistance, usually referred to as Yf, is defined as the instantaneous stress value required to continue to plastically deform a material to cause it to flow

the resistance to deformation, for a given material, varies with changes in temperature, and the rate of deformation; therefore, we can write:

Y_{f}=f(ε,\dot{ε},T)

: It is expressed in Mpa.

### Extrudability

Alliages d'extrusion commerciaux:

| | Extrudabilitée |
|---|---|
| Type d'alliage | (% of rate for 6063) |
| 1350 | 160 |
| 1060 | 135 |
| 1100 | 135 |
| 3003 | 120 |
| 6063 | 100 |
| 6061 | 60 |
| 2011 | 35 |
| 5086 | 25 |
| 2014 | 20 |
| 5083 | 20 |
| 2024 | 15 |
| 7075 | 9 |
| 7178 | 8 |

The table above shows the extrudability of aluminum according to its type. Any identical parameters by the way, is designated by extrudability the extrusion rate obtained. Extrudability derives from t“e “resistance to deformat”on”, Yf, mentioned above.

### BRIEF DESCRIPTION OF THE DRAWINGS

FIG. 1 is a table giving, at the same interior volume, the liner mass gains induced by the type of liner chosen.

FIG. 2 is a graph showing temperature-dependent permeation properties for 6 candidate metals.

FIG. 3 is a schematic presentation of backward extrusion in 3 steps namely: step [A] setting up the blank (3); then step [B] backward extrusion; and finally step [C] release of the part

FIG. 4 is a schematic cross-section view of an aluminium blank (3) and what it will become in fine lines (5)

FIG. 5 is a schematic overview, showing the blank (3) just before deformation

FIG. 6 is a view, in close-up, showing the blank (3) just before deformation

FIG. 6B is a view, in close-up, showing, another type of blank (3), just before deformation

FIG. 7 is a view, schematic global, showing t½ ½ liner (5) and its end (5b) just after deformation

FIG. 8 is a view, in close-up, showing the tip (5b) of t½½ liner just after deformation, the punch (1) having begun to be removed.

FIG. 9 is a view, schematic global, showing t½½ liner (5) released.

FIG. 10 is a view, schematic global, showing the ½½ liners together.

FIG. 11 is a property “f “resistance to deformat”on” of an aluminum, type 1000, as a function of t“e “rate of deformat”on” and temperature.

FIG. 12 illustrates an evolution of the properties of a mold steel (e.g., H13 HRC50) as a function of temperature. These properties were represented as a percentage of the values at 21° C. of Yo'ng's modulus and t“e “fracture stren”th”.

FIG. 13 is a finite element numerical simulation result of backward extrusion.

FIG. 14 is a close-up showing the optimized draft (3).

### DESCRIPTION OF THE PREFERRED EMBODIMENTS

The present invention describes the optimal structure of a liner for a composite tank for the storage of gas and in particular hydrogen at high pressure.

FIG. 14 includes the following elements:

(1) punch

(1b) extension of the punch (1) i.e., part used to ensure precise guidance of the punch (1)

(2) and (4) counterform

(2b) Precision bore, counterform, guiding the extension (1b) of the punch (1)

(3) blank metal preform, sometime called “slung”

(3′) and (3″) local overthickness of the blank intended to avoid cooling of the blank, by conduction, when waiting at the beginning of backward extrusion.

(5) cylindrical part, large diameter, of the ½ metal liner.

(5b) cylindrical end, small diameter, raw wire mesh backward extrusion of ½ metal liner

(5c) transition zone between large (5) and small diameter (5b) of the ½ metal liner; area sometimes called dome, area corresponding to the optimized blank

(5D) entire assembled metal liner (bottle)

(5D′) and (5D″) ½ machined metal liners (half bottles)

(5th) threaded bore of the ½ liner 5b′ (5F) gap between the punch (1) and the counterform (2) ensuring the calibration of the thickness of the large diameter cylindrical part (5) of the ½ liner.

(5b′) end, after recovery in machining, of the ½ metal liner.

(5′) ½ twin metal liner

(5′b′) end, after resumption in machining, of the twin metal liner

(5″) link area between the two ½ liners

(6) Punch guide trolley (1)

(7) means of guiding the trolley (6)

(8) and (8′) means of heating the ½ metal liner (5)

FIG. 2 shows the evolution of the permeability of metals as a function of temperature. We note that for the ambient temperature (abscissa 3.4 on the graph), the most interesting metals are for example and in preferential order: gold, copper, aluminum, austenitic iron, nickel, any other metal or metal alloy not being excluded.

Except for very special applications (space for example) we can skip gold (density 19.3). Copper and aluminum come next. Copper at a density of 8.96, aluminum at a density of 2.7 or 3.3 times lower. In addition, aluminum has excellent extrudability and good corrosion resistance. We will therefore analyze here, as an example, a liner using this metal, which in no way restricts the scope of the patent to other metals and alloys.

We mentioned that aluminum has a permeation 333 times better than HDPE. In the context of the invention, we use a liner of a thickness “e” in cylindrical zone of large diameter (5) between 0.1 mm and 3 mm, in the frame of a type III tank; If we consider a thickness “E” of composite structure typically between 16 and 32 mm thick, our invention relates to a range of liner thicknesses compared to thickness of composite structure “e/E” between 0.3% and 19%. Confer the table below.

| | |
|---|---|
| epaiseur | epaiseur liner (mm) |

| enveloppe | 0.1 | 3 |
|---|---|---|
| 16 | 0.625% | 18.75% |
| 32 | 0.313% | 9.38% |

A type IV liner, made of HDPE has an “e/E” value of 43.9%! Let's take, as an example, for our aluminum liner, a reasonable thickness of 0.7 mm, or an “e/E” of 4.54%. With this thickness of 0.7 mm, our performance, in permeation, will be 33.3 times better than a 7 mm HDPE liner. Technologically, the liner will be robust enough to withstand the load suffered, during the guipage of the composite structure; note that it is possible, if necessary, to inflate it to stiffen it, or to fill it for example with a frozen fluid.

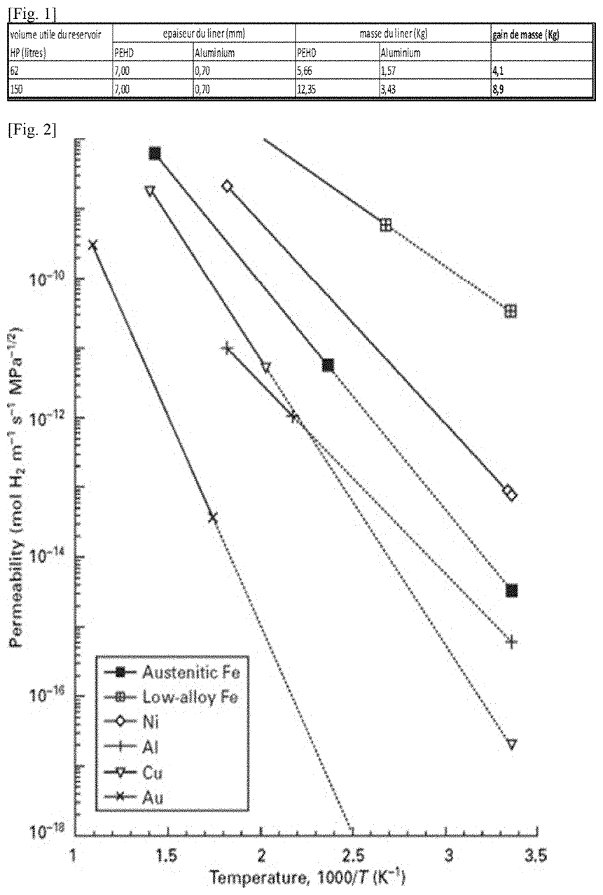

The benefits brought by an aluminum liner, for example 0.7 mm, in addition to permeation, are as follows (for example for a tank of 62 liters)
reduction of the mass of the liner by 4.1 Kg or 72.3% (the mass decreases from 5.7 to only 1.6 Kg) (see FIG. 1)
reduction of the composite structure mass of 12 Kg or 29.1% (the mass increases from 41.4 to 29 Kg) such a reduction, naturally induces a sharp decrease in the material cost of the tank.
so reduction of the total mass of the tank of 16.1 Kg or 34.3% (the total mass goes from 47.1 to 30.9 Kg) (excluding inserts), such a reduction is interesting with regard to the lightening of the vehicle. Our liner is its own insert.
reduction of the outer diameter of the tank by 14.2 mm or 3.4% (the diameter increases from 419.8 mm to 405.6 mm) such a reduction is interesting with regard to integration into the vehicle.

The process for obtaining such a liner (5D) is based on the principle of backward extrusion.

As explained above, our invention consists in making a type III liner, preferably made of aluminum, having extremely thin walls compared to the state of the art.

To make Type III liners, manufacturers use type 6000 aluminum. However, to the extent that aluminum will be contained in a composite envelope that will take all the efforts, it is not necessary to use a structural aluminum type 6000. Indeed, it is expensive and has a poor elongation at break (8%). As part of the invention, we will implement an aluminum of the 1000 series, because it offers: an excellent elongation at break of 25% and as we mentioned earlier: It is observed that the family of type 1000 is the most easily extrudable. In particular the 1350 offers an extrudability of 160% compared to a 6063. We therefore use the family 1000 which is made of pure aluminum at 99% or more, namely in particular and in a non-exhaustive way, the following references AFNORNFA 02 104: 1350, 1199, 1145, 1199, 1100, 1070, 1060, 1050, 1A99, 1A97, 1A95, 1A93, 1A90, 1A85, 1A80, 1A80A!

Before the backward extrusion operation, it is strategic to have annealed the material.

When backward extrusion ½liners reverse the “backward extrusion ratio” OR is very unfavorable because the radius of the ½liner (5) is very large compared to the radius of the blank (3) and because the gap (5F) (which will drive thickness of the ½liner in its large diameter (5)) is extremely thin, which causes considerable resistance to the flow of the metal.

The “backward extrusion force”, the parameters of which we have given previously, must be minimized: in order not to reach the buckling resistance of the punch (1) and not to require an oversized press. As illustrated in FIG. 11 It is the reason why the blanks (3), previously treated in the annealed state, are implemented in a strain rate range between 50 s-1 and 0.01 s-1, coupled to a temperature range of said blanks, comprised between 400° C. and 645° C., the above-specified range of temperature and strain rate having the objective of reducing the stresses to be applied in order to achieve shaping in one single pass with minimum effort on the tools.

To the extent that we have fixed geometric parameters: such as the diameter of the ½liner and the dimension of the gap (5F) between punch (1) and against shape (2): We have more than one parameter left, on which we can act, namely the “Resistance to deformation”!

The table, three-dimensional in FIG. 11, is the result of our characterization work on an aluminum of the 1000 family. Thanks to this table, we observe the combined effects of the rate of deformation and the temperature, on the resistance to the deformation. It can be seen that the “Resistance to deformation” decreases, when the rate of deformation decreases, and that the so-called “resistance to deformation” also decreases, when the temperature increases.

In order to achieve backward extrusion, according to the invention, we must achieve a value of “Resistance to deformation” which must be less than 20 MPa.

When backward extrusion the blank reverse (3); We therefore use the deformation rate range between 50 s⁻¹ and 0.01 s⁻¹, coupled with the temperature range between 400° C. and 645° C. That is, the blank (3) must be in this area, during the backward extrusion operation.

Recall that the blank, prior to backward extrusion, must be in a state called “annealed” so as to facilitate its shaping by backward extrusion.

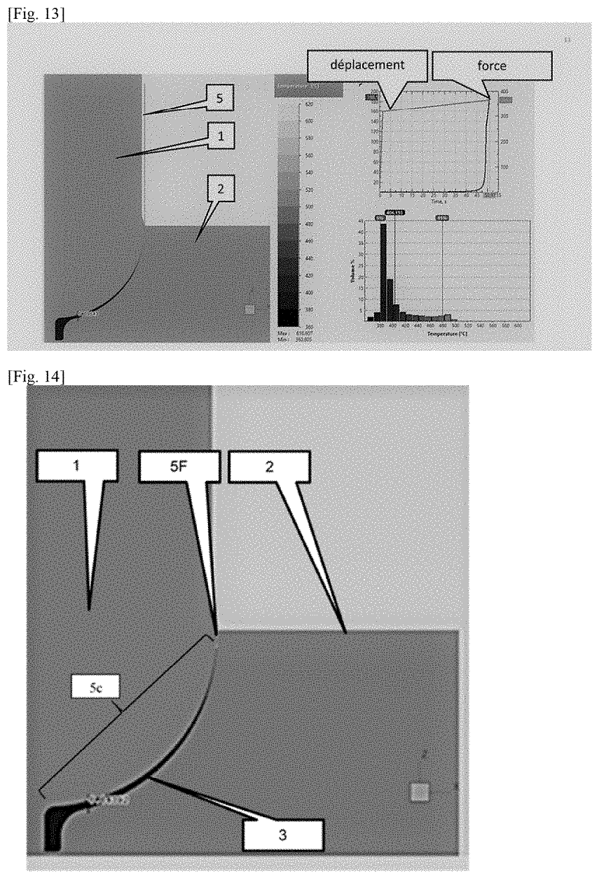

If we heat the blank (3), for example to 620° C., the time to place it in the backward extrusion tools and to approach the punch of the blank, it will be able to start cooling even before the beginning of backward extrusion! As shown by the numerical simulation of FIG. 13, for a blank heated to 620° C., if one has heated, the tooling, punch (1) and counterform (2), to 380° C., in 49 seconds of compression, the heat exchanges between the aluminum and the steel of the tooling will be such, in the zone of the dome (5c), that the aluminum of the blank will descend to 380° C. at the beginning of the backward extrusion of the cylindrical part (5) of the ½ liner! the total time, of backward extrusion, being only 52.8 seconds (including 1.58 seconds of punch lift).

So the backward extrusion of the tubular part (5), calibrated by the gap (5F), lasts only 2 seconds. If we use a preformed blank having a geometry substantially close to that of the dome (see FIG. 14), we only have in this case said tubular part (5) to produce: we count 1.58 seconds of approach, and opening of the tooling, so it is enough in total of 5.16 seconds to produce a ½liner!

During backward extrusion, in the case of calculation presented: the deformation speed, s⁻¹, changes from 0.018 to 0.19.

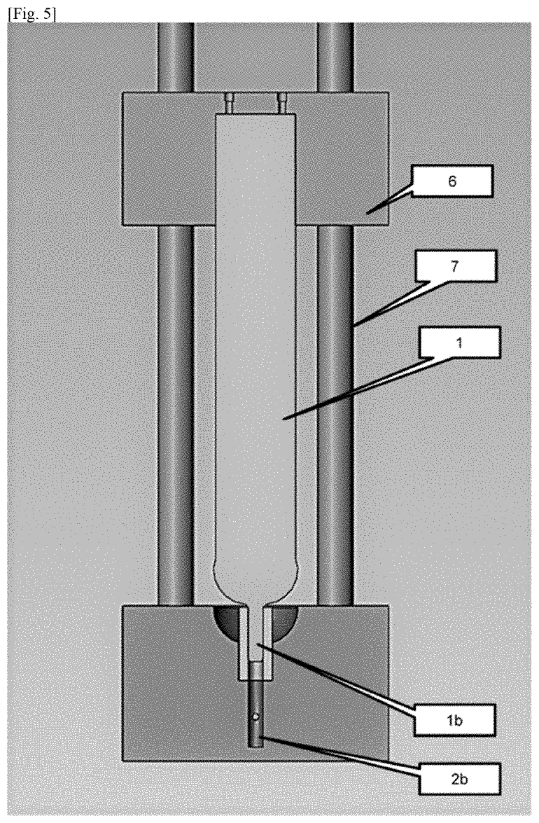

In order to reduce heat exchange, before compression, the blank (3) may have thicknesses (3′) and (3″), as shown in FIG. 4. We can also: increase the rate of deformation, and optimize the shape of the blank (3) so that it is very similar to the shape of the dome (5c) (see FIG. 14). Such a shaping makes it possible to reduce or even eliminate the time devoted to forming the dome (5c), so we go directly to the backward extrusion of the tubular part (5) of the ½liner. This shaping substantially in dome (5c) of the blank (3) can be obtained beforehand by: stamping, molding, repelling, machining, or additive manufacturing.

Note that the “Mass Heat Capacity” also called “Specific Heat” (J·kg⁻¹·K⁻¹) is 448 for steel, compared to 921 for aluminum. So the “heat capacity by volume” of aluminum is 6 times higher than that of steel! In order to reduce heat exchange, before compression, we can apply an original strategy: instead of heating the tooling globally (1) and (2) to, for example, 380° C., we can act differently. This is what we will call “optimized heating”.

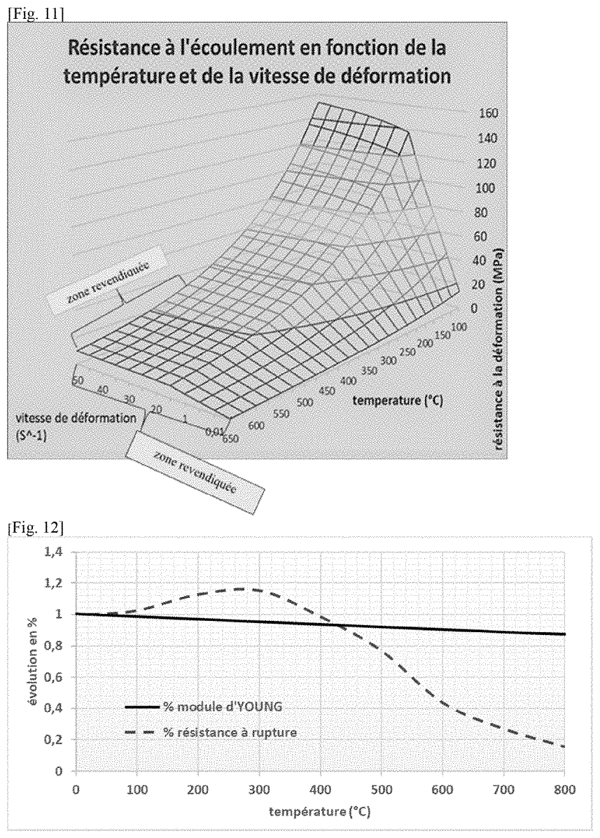

If we analyze FIG. 12, we see that raising the temperature of the tooling beyond 400° C., is detrimental to its mechanical resistance. On the other hand, in the context of optimized heating: if we keep the tooling at a reasonable temperature, for example at 275° C., we bring to for example 600° C. only a very small thickness of said tooling corresponding to the zone (5c) of the dome. In so far as steel tooling consists of a punch (1) and a counterform (2) it is sufficient to heat locally, one or each, faces of the tooling next to the zone (5c) of the ½liner on a thickness at least equal to 3 times the thickness of said zone (5c) of the ½liner; This heating, optimized, very localized and very fast, can be carried out by any means known by the man of the art such as heating by: infrared, induction, laser.

The blank (3) heated to for example 600° C. being introduced quickly into the counterform (2); the first principle of optimized heating, consists in heating to, for example, 600° C., locally and in a very short time, the area of the tooling where the dome will be (5c), and on a thickness at least equal to 3 times the local thickness of said dome (5c). It is necessary to bring just the necessary energy to cancel any heat transfer between the blank (3) and the tooling (2) and (1). By doing so, the blank is kept around, for example, 600° C. and minimizes the “resistance to deformation” of the material of the blank (3). We use the following three heated tooling area options: either (2) and (1), or (1), or (2).

the blank (3) heated to for example 500° C. being introduced quickly into the counterform (2); the second principle, optimized heating, consists in heating to for example 640° C., locally and in a very short time the area of the tooling where the dome will be (5c), we apply in this zone just the energy necessary to heat the blank (3) from for example 500 to 620° C. This operation is carried out by “unsteady heat transfer” between the blank (3), colder, and the area next to the tooling, warmer, at for example 640° C. By acting in this way, we carry out an “unsteady transfer” of calories from the tooling to the blank, which allows while heating the blank, to cool the tooling.

The area of the tool corresponding to the location of the dome (5c) is heated with precision, the heating being monitored by the measurement of the transmitted energy, by the chosen means of heating and by means of measurement, such as infrared or any other means of measurement known to the man of the art. This heated area being thin and warmer than the rest of the tooling, by expanding slightly, is compressed which improves its mechanical properties. Note: you can choose to heat only the area next to (5c) of the punch (1) or the area next to (5c) of the countershape, or both areas.

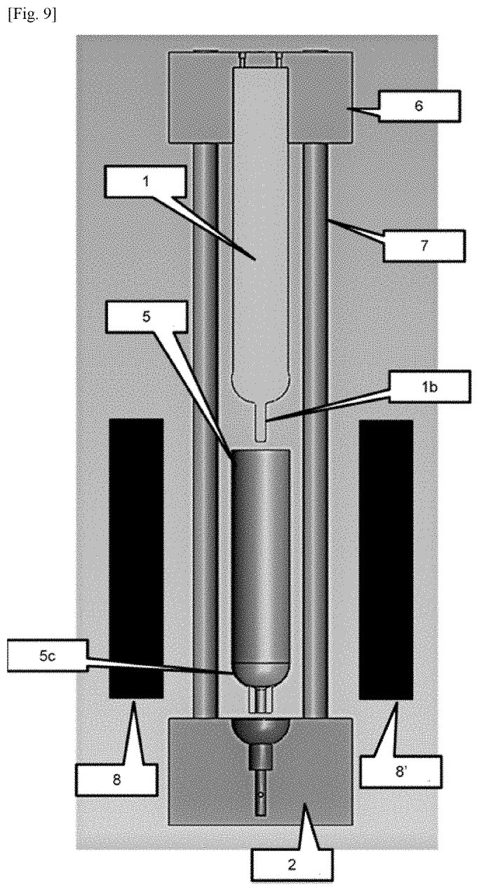

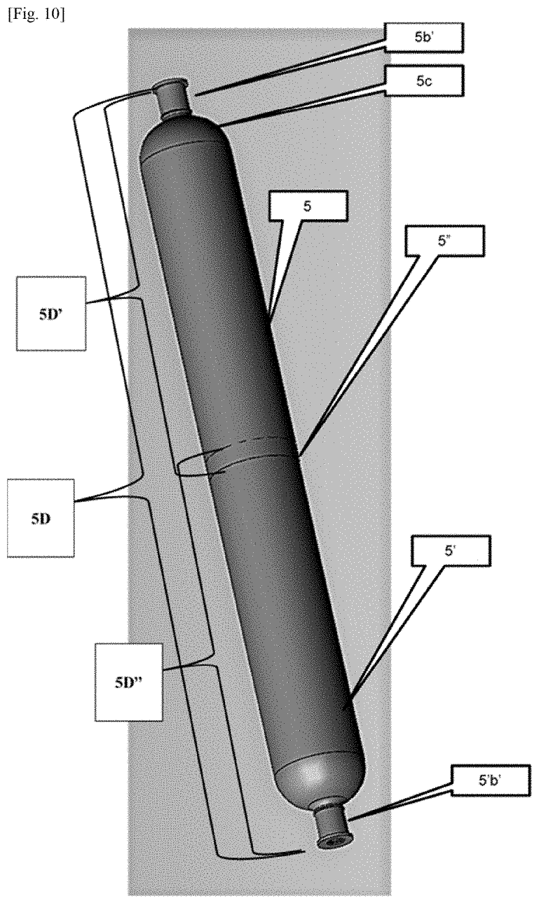

During backward extrusion, the cylindrical zone (5) tends to cool down, which results in a decrease in diameter . . . if nothing is done, it becomes impossible to remove the punch (1) from the cylindrical zone (5) of the ½liner. Our solution is to heat the cylindrical zone (5) of the ½liner, with any means known by the man of the art. In FIG. 9 we have represented these means (8) and (8′) for instance infrared lamps . . . .

After having taken over in machining the end (5b′) and proceeded to the tapping (5th) of the end (5b) of the ½liner, it is then possible to end, by frettage, the said ½liner (5D′) with its twin (5D″). In the case of ½liners having walls of 0.5 mm, this operation requires a temperature differential between the 2 twins, it can be carried out by heating, for example to 200° C., one of the two ½liners, by aligning it, then sliding it on its twin, cold, and letting cool the whole.

This fretting can be simple or assisted by solder or glue.

If the wall (5) is thicker than 0.5 mm either we can increase temperature difference between ½ liners or it is necessary to use two tools of different diameter, so as not to lead to fretting difficulties. Note that we can consider end-to-end welding, or we can also use a shell, or collar (short tube) of an appropriate preheated diameter to fret two ½liner of the same diameter and thickness.

Metal bottles (5D), characterized by the fact that one of the two half-bottles for example (5D″) is one-eyed, that is, it does not have an end (5b), may a one-eyed dome (5c) blind (not pierced)

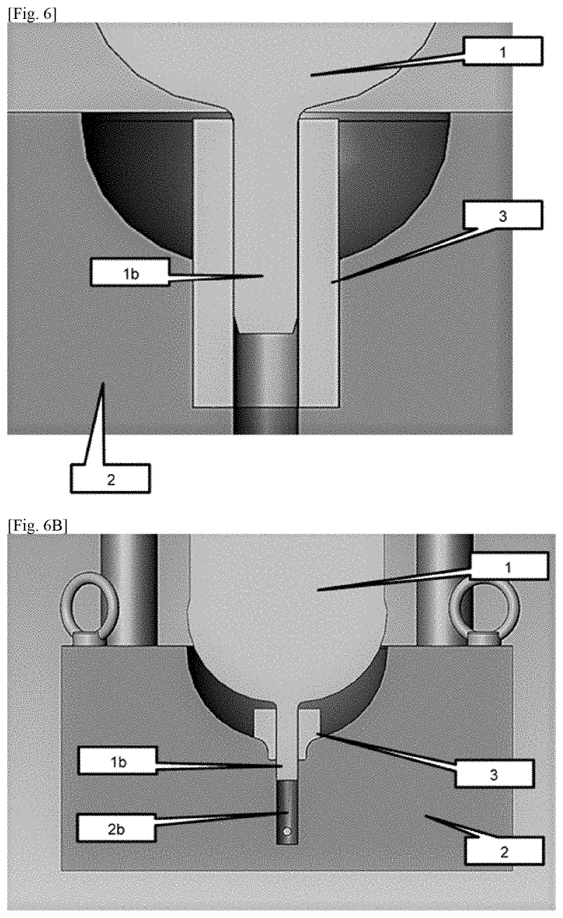

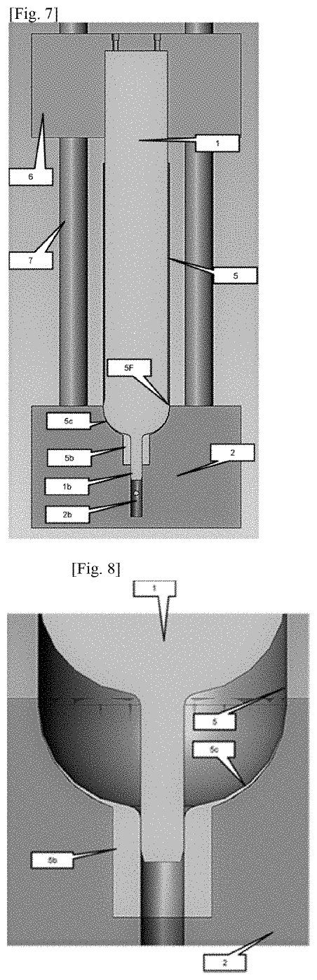

First level precision guidance: it is impossible, with a conventional press, to obtain the guidance precision essential to achieve the thicknesses of super thin walls, object of the invention. It is therefore necessary to use a dedicated guidance tool, which is placed between the trays of the press. FIGS. 5 and 7 show the principle of such tooling. This tool includes: a guide trolley (6) of the punch (1), this trolley slides along precision columns (7), said columns being embedded in the “counterform” (2).

Second level precision guidance: in order to perfectly master the guidance, the punch (1) is extended by an extension (1b). Said extension has a dual role: on the one hand it guarantees the shaping and calibration of the part (5b) of the ½liner (5), and on the other hand it slides into the calibrated bore (2b) of the “counterform” (2) thus ensuring the perfect guidance of the punch (1) in the counterform (2).

### IN SUMMARY

Metal bottle (5D) composed of 2 half bottles (5D′) and (5D″) intended to serve as a light liner for type III composite tanks, having very low thickness “e” of its cylindrical zone (5)-(5′), thickness between 0.12 mm and 0.98 mm, Metal bottle (5D′) or (5D″), using a blank (3) which will be used in order to produce the metal bottle made of one of the following metals: gold, copper, aluminum; said aluminum being selected pure at 99%, or more, namely following the AFNOR NFA02-104 nomenclature in particular and not exhaustively among the following references: 1350, 1199, 1145, 1199, 1100, 1070, 1060, 1050, 1A99, 1A97, 1A95, 1A93, 1A90, 1A85, 1A80, 1A80A.

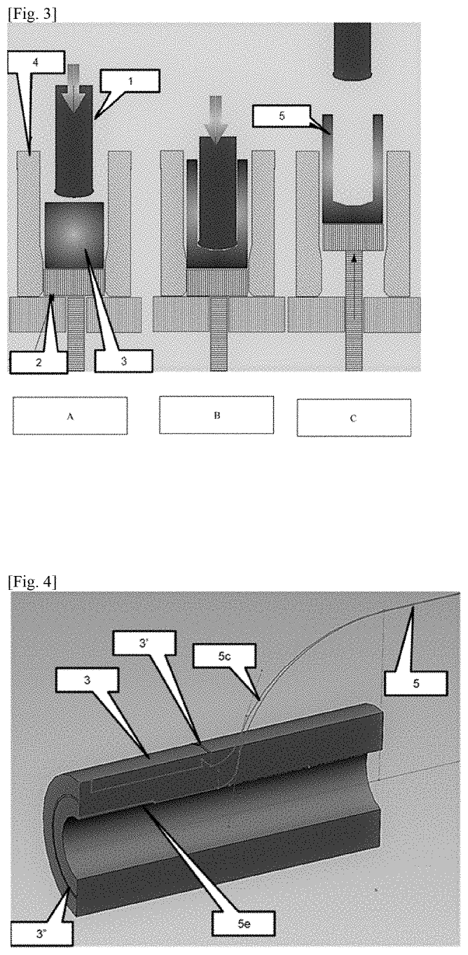

Metal bottle (5D′) or (5D″), knowing that the backward extrusion consists in shaping by reverse extrusion, the metal of the blank using a tool, transformation field optimized in that, during the reverse spinning of the blank (3); we specify, as illustrated in FIG. 11, that the blanks (3), previously treated in the annealed state, are implemented in a strain rate range between 50 s-1 and 0.01 s-1, coupled to a temperature range of said blanks, comprised between 400° C. and 645° C., the above-identified range of temperature and strain rate having the objective of reducing the stresses to be applied in order to achieve shaping in one single pass with minimum effort on the tools. Metal bottle (5D′) or (5D″), as illustrated in FIG. 3 and in order to reduce heat exchange between the blank and the counterform (2) the tooling of shaping before compression, the blank (3) is bearing extra thicknesses rings (3′) and (3″), extra local thicknesses which limit the contact and so thermal flow between the blank and the counter shape (2).

Metal bottle (5D′) or (5D″), in order to reduce heat exchanges and thus the shaping time before compression, the blank (3) is optimized by the fact that the shape of said blank (3) has a geometry very similar to the shape of the dome (5c) to be achieved, is thus passed almost directly to the backward extrusion of the tubular part (5) of the ½liner, this shaping substantially in dome (5c) of the blank (3) can be obtained beforehand by: stamping, moulding, repelling, machining, additive manufacturing.

Metal bottle (5D″), having one of the two half-bottles constituting it is one-eyed, that is to say that it does not have an end (5b), may a dome (5c) not pierced.

First optimized method of making ½ Metal bottle (5D) or (5D″) the blank (3) being previously heated to for example 600° C. then quickly introduced into the counterform (2), process, that consists in heating to for example 600° C., locally and in a very short time, the area of the tooling where the dome will be (5c), and on a thickness at least equal to 3 times the local thickness of said dome (5c), in this procedure, it is necessary to bring just the energy necessary to cancel any heat transfer between the dome (5c) of the blank (3) and the tooling by choosing see picture 3 and picture 6 one of the following three heated tooling zone options: either (2) and (1), or only (1), or only (2).

Second optimized method of making ½ Metal bottle (5D) or (5D″), the blank (3) being previously heated to for example 500° C., then quickly introduced into the counterform (2), a process optimized: by the fact that it consists in carrying out an unsteady heat transfer, from the tooling, to the blank (3), said tooling being heated to for example 640° C., locally and in a very short time, at the level of the tooling area next to the dome (5c), choosing one of the following three heated tooling zone options: both (2) and (1), or only (1), or only (2).

Method of making ½ Metal bottle (5D) or (5D″), optimized by the fact that, during backward extrusion, the cylindrical zone (5) of the ½liner is heated with any means known by the skilled person.

Method of making ½ Metal bottle (5D) or (5D″), optimized by the fact that to guide the punch (1) is used a precision guide tool comprising: a guide trolley (6) of the punch (1), this trolley slides along precision columns (7), said columns being embedded in the “counterform” (2).

Method of making ½ Metal bottle (5D) or (5D″), optimized by the fact that to guide the punch (1) in the “counterform” (2) is used an extension (1b) of the punch, which slides and is guided by the calibrated bore (2b) of the “counterform” (2)

Method of making Metal bottle (5D) or (5D″), after having taken over in machining the end (5b′) and proceeded to the tapping (5th) of the end (5b) of the ½liner (half bottle), it is then possible to achieve, by fretting, the said ½liner (5D′) with its twin (5D″), this operation need that there must be a temperature differential achieved by heating, for example at 200° C., one of the two ½liners, by aligning it and then sliding it on its twin, cold, and letting cool everything, this said frettage can be simple or assisted by solder or glue.

1. A metal bottle (5D) comprising 2 half bottles suitable to serve as a light liner for type III composite tanks, wherein the metal bottle has a thickness “e” of the metal bottle's cylindrical zone between 0.12 mm and 0.98 mm,

2. The metal bottle according to claim 1, wherein the blank comprises one of the following metals: gold, copper, and aluminum.

3. The metal bottle according to claim 2, knowing that the backward extrusion consists in shaping by reverse extrusion, the metal of the blank using a tool, transformation field characterized in that, during the reverse spinning of the blank (3); wherein the blanks (3), previously treated in the annealed state, are implemented in a strain rate range between 50 s⁻¹ and 0.01 s⁻¹, coupled to a temperature range of said blanks, comprised between 400° C. and 645° C., the above-claimed range of temperature and strain rate having the objective of reducing the stresses to be applied in order to achieve shaping in one single pass with minimum effort on the tools.

4. The metal bottle according to claim 1, wherein in order to reduce heat exchange between the blank and the counterform (2) the tooling of shaping before compression, the blank (3) is characterized by extra thicknesses rings (3′) and (3″), extra thicknesses which limit the contact between the blank and the counter shape (2).

5. The metal bottle according to claim 1, wherein the shape of said blank (3) has a geometry very similar to the shape of the dome (5c) to be achieved, is thus passed almost directly to the backward extrusion of the tubular part (5) of the ½liner, this shaping substantially in dome (5c) of the blank (3) can be obtained beforehand by: stamping, molding, repelling, machining, additive manufacturing.

6. The metal bottle according to claim 1, wherein one of the two half-bottles constituting it is one-eyed, that is to say that it does not have an end (5b), may a dome (5c) not pierced.

7. A method of making the metal bottle of claim 1, comprising:
heating a blank to at least 600° C., and
introducing the blank into the counterform (2),
wherein the heating of the blank is performed locally and in a very short time, the area of the tooling where the dome will be (5c), and on a thickness at least equal to 3 times the local thickness of said dome (5c), in this procedure, it is necessary to bring just the energy necessary to cancel any heat transfer between the dome (5c) of the blank (3) and the tooling by choosing see picture 3 and picture 6 one of the following three heated tooling zone options: either (2) and (1), or only (1), or only (2).

8. A method of making the metal bottle of claim 1, the method comprising:
heating a blank to at least 500° C., and
introducing the blank into the counterform (2),
wherein the heating comprises carrying out an unsteady heat transfer from tooling to the blank (3), said tooling being heated to at least 640° C., locally and in a very short time, at the level of the tooling area next to a dome (5c), choosing one of the following three heated tooling zone options: both (2) and (1), or only (1), or only (2).

9. The method of claim 7, wherein during backward extrusion, the cylindrical zone (5) of the ½liner is heated.

10. The method of claim 7, further comprising guiding a punch (1) using a precision guide tool comprising: a guide trolley (6) of the punch (1), wherein the trolley slides along precision columns (7), said columns being embedded in the “counterform” (2).

11. The method of claim 7, further comprising guiding a punch (1) in the “counterform” (2) using an extension (1b) of the punch, wherein the extension of the punch is capable of sliding and is guided by the calibrated bore (2b) of the “counterform” (2)

12. The method of claim 7, further comprising, after having taken over in machining an end (5b′) and proceeded to the tapping (5th) of the end (5b) of the ½ liner (half bottle), fretting the said ½ liner (5D′) with its twin (5D″), wherein a temperature differential achieved by heating a first of the two ½ liners, aligning the first of the two ½ liners with a second of the two ½ liners and sliding the first of the two ½ liners on the second of the two ½ liners while the second of the two ½ liners is cold, then allowing the assembly of the first and second ½ liners to.

13. The metal bottle of claim 2, wherein the metal is aluminum, said aluminum being selected pure at 99% or more in accordance with AFNOR NFA02-104 nomenclature.
